(19) United States
(12) Patent Application Publication
(10) Pub. No.: US 2022/0235242 A1
(43) Pub. Date: Jul. 28, 2022

(54) INSULATING COATING COMPOSITION

(71) Applicant: PPG Coatings (Kunshan) Co., Ltd., Jiangsu (CN)

(72) Inventors: Luoyi Zhu, JIangsu (CN); Richard Holliday, Aberdeenshire (GB); Minmin Yuan, Jiangsu (CN)

(73) Assignee: PPG Coatings (Kunshan) Co., Ltd., Jiangsu (CN)

(21) Appl. No.: 17/620,223

(22) PCT Filed: Jun. 19, 2020
(86) PCT No.: PCT/CN2020/096610

§ 371 Date: Dec. 17, 2021

(51) Int. Cl. C09D 163/10; C09D 7/65; C09D 7/40; C09D 7/61; C09D 5/18

(52) U.S. Cl. CPC C09D 163/10; C09D 7/65; C09D 5/185; C09D 7/61; C09D 7/70

(57) ABSTRACT

The present invention relates to an insulating coating composition, a substrate coated with such insulating coating composition and a method for protecting a substrate by using the insulating coating composition. The insulating coating composition comprises at least a) chemically toughened epoxy resin component, wherein the ratio of chemically toughened segments, which are elastomeric segments and bonded via chemical reaction on the epoxy resin, is in a range of 20-49 wt %, based on the total weight of said chemically modified epoxy resin component; b) a curing agent; c) reinforcing fibers; and d) low-density fillers with a density ranging from 0.05-0.7 g/cm³, preferably 0.08-0.5 g/cm³, more preferably 0.1-0.4 g/cm³.

### TECHNICAL FIELD

The present invention relates to an insulating coating composition, a substrate coated with such insulating coating composition, and a method using the insulating coating composition to protect a substrate.

### BACKGROUND

During the exploration, storage and shipment of Liquid Natural Gas (LNG, which generally could be as low as −162° C.), there could be leaking risks of the liquified natural gas caused by crashing, severe vibration or long-term corrosion. The leaked liquid having ultralow temperature would quench the surrounding steel structure in a short period of time, leading to a cold brittleness phenomenon of the steel, which causes the steel to crack or break resulting in thereby a structural collapse and subsequent disasters.

To slow down the sharp temperature drop of the steel structure when encountering a liquid having an ultralow temperature, the steel structure will be subjected to thermal insulation protection with, for example, polyurethane foamed plastics (PUR), polyisocyanurate (PIR), foam glass, silica aerogel felt, etc. Some conventional materials such as rockwool and bulk ceramic fibers are prohibited due to harmfulness to humans. Thermal insulation protection coatings are receiving more and more considerations in engineering for their convenient workability and durability.

In prior arts, epoxy resin based thermal insulation protection coatings are generally used for steel structures' corrosion resistance and thermal insulation protection. For example, CN105658748A discloses a powder coating composition comprising at least one reinforcing fibers and an adhesion accelerator based on epoxy resin. The composition is coated on the substrate such as steel to provide corrosion resistance and chip resistance. But there is no suggestion regarding thermal insulation protection under ultralow temperature conditions.

However, when encountering ultralow temperature, these prior art epoxy resin based coatings generally crack or shed, due to the coating contractions caused by an inner stress greater than a cohesive force of the coating or an adhesion force of the coating on the substrate/primer. Therefore, the thermal insulation properties will be deteriorated, and the expected protections cannot be achieved. In severe cases, flame resistant coatings on the substrate could simultaneously crack or even shed, so as to further deteriorate fire resistant properties. Moreover, these normal epoxy resin based thermal insulation coatings for low temperature use generally have higher thermal conductive coefficient and lower thermal insulation effectiveness.

Therefore, there is an urgent need to improve the thermal insulation protection coatings based on purely epoxy resins, to overcome these defects in prior arts.

### SUMMARY OF THE INVENTION

The inventors of the present invention have found through extensive experiments and continuous efforts that the insulating coating composition of the present invention can solve the above problems in the prior art. In particular, with the insulating coating composition of the present invention a coating film can be obtained having more flexibility and higher thermal insulation effectiveness, increasing freezing resistance property of a substrate, particularly low temperature cracking resistance (in particular at ultralow temperatures, for example, as low as −120° C. or −160° C., or even as low as −180° C.), meanwhile protecting the underlying existing coatings on the substrate, such as the coatings having flame resistant ability (flame resistant coating), thereby achieving better fire resistant property. Moreover, the composition according to the present invention has convenient workability and durability. Particularly suitable substrates for the present invention are metallic substrates, in particular steel, zinc plated steel, aluminum, stainless steel or steel constructions.

Therefore, in a first aspect, the present invention relates to an insulating coating composition, comprising at least the following:

a) chemically toughened epoxy resin component, wherein the ratio of chemically toughened segments, which are elastomeric segments and bonded via chemical reaction on the epoxy resin, is in a range of 20-49 wt %, such as 23 to 45% by weight, or 32-42% by weight, based on the total weight of said chemically modified epoxy resin component;

b) curing agent;

c) reinforcing fibers; and

d) low-density fillers with a density ranging from 0.05 to 0.7 g/cm³, preferably 0.08 to 0.5 g/cm³, more preferably 0.1 to 0.4 g/cm³.

In another aspect, the present invention relates to a substrate, on which the above insulating coating composition is coated.

In a further aspect, the present invention relates to a method for protecting a substrate, comprising the following steps:

(1) providing a substrate optionally coated with a first coating; and

(2) applying the above insulating coating composition on the substrate or the first coating of the substrate.

### DETAILED DESCRIPTION OF THE INVENTION

Other than in any operating examples, or where otherwise indicated, all numbers expressing quantities of ingredients, reaction conditions and so forth used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used in this specification and the appended claims, the articles “a,” “an,” and “the” include plural referents unless expressly and unequivocally limited to one referent.

Moreover, in the present specification and appended claim thereof, the term “(meth)acrylic acid”, “(meth)acrylic” or “poly(meth)acrylic” or like expressions each means monomers or compounds having (meth)acryloyl groups, and comprises acrylic acid, methacrylic acid, acrylamide, methylacrylamide, acrylate or methacrylate and the like and the corresponding polymers thereof, preferably acrylic acid, methacrylic acid, acrylate or methacrylate and the like.

The various embodiments and examples of the present invention given in the present specification should not be understood as limitations on the scope of the present invention.

The composition according to the present invention contains a thermoset polymer matrix as a binder. The binder is generally understood as non-volatile substances, apart from various functional additives (such as fillers or plasticizers) in a coating, which are base components for forming film, such as polymers or resins, and form a coating film upon, such as subjecting to heating or reaction with a curing agent. The chemically toughened epoxy resin component defined according to the present invention constitutes a major part of the thermoset polymers, that is, accounts for preferably at least 60% by weight, more preferably at least 75% by weight, most preferably at least 85%, in particular at least 95% by weight or 100% by weight of the total amount of thermoset polymer binder in the composition. The chemically toughened epoxy resin component is important to the improvement of the flexibility of the coating formed by the composition of the present invention. In an advantageous embodiment, the thermoset polymer binder in the composition of the present invention entirely consists of the chemically toughened epoxy resin component defined according to the present invention.

In the present invention, “chemically toughened epoxy resin component” means a product directly obtained by purposely bonding toughening segments having flexibility to an epoxy resin via chemical reactions such as grafting, condensation or adduction etc., or a product obtained by admixing non-toughened epoxy resin and the afore-said directly obtained chemically toughened product. The toughness of the epoxy resin is adjusted by controlling the ratio of the toughening segments. The toughening segments generally are elastomeric segments. The elastomeric segments are segments derived from the elastomers (including rubber or polymer) well known to one skilled in the art, which have rubber elastomeric property, deform under a certain stress load and are elastomeric resilient upon removal of the stress. There are diversified ways to chemically toughen an epoxy resin, which are known or readily available to one skilled in the art.

In the present invention, suitable chemical modification can mean directly linking the toughening segments, in particular elastomeric segments, by chemical reactions at an epoxy resin through ring-open of epoxy groups, so as to impart epoxy resin certain flexible and elastomeric properties.

In an advantageous embodiment, the toughening segments particularly are linear or branched elastomeric segments having more than 6, preferably more than 8 carbon atoms such as 6 to 100 or 8 to 50 or 30 carbon atoms, optionally having ester, acryloyl, urethane and/or ether groups. Therefore, these segments correspondingly include, but not limited to, polyester segments reacted from aromatic or aliphatic polyols and polyacids, poly(meth)acrylic segments, polyurethane segments, polyether segments. Moreover, in another advantageous embodiment, the segments also include some other elastomeric segments, in particular segments from styrenic polymers, such as styrene/butadiene elastomers, polyolefin elastomers, chloroprene rubber, butadiene-acrylonitrile rubber and polyamide elastomers, etc.

Correspondingly, in a preferred embodiment of the present invention, the chemically toughened epoxy resin component comprises or preferably consists of at least one selected from polyester modified epoxy resin, poly(meth)acrylic modified epoxy resin, polyurethane modified epoxy resin, polyether modified epoxy resin, styrenic polymers modified epoxy resin, polyolefin modified epoxy resin and polyamide modified epoxy resin; preferably polyester modified epoxy resin and/or poly(meth)acrylic modified epoxy resin; more preferably polyester modified epoxy resin.

Moreover, the chemically toughened epoxy resin can also be obtained by admixing non-toughened epoxy resin with epoxy resin that has been chemically toughened as above. Therefore, one exemplary operation is to thoroughly mix a chemically toughened epoxy resin and non-toughened epoxy resin at a specified ratio under a condition of advantageous stirring and melting where necessary, so as to form the chemically toughened epoxy resin component. Thereafter, they are used as thermoset polymer binder or the major part thereof in the composition.

In the present invention, either using epoxy resins obtained by directly chemical modification or using a mixture thereof with non-modified epoxy resins as the chemically toughened epoxy resin, the ratio of the chemically toughened segments in the modified epoxy resin component are essential. In order to achieve a more favored flexible effects while maintaining low temperature cracking resistance, the ratio of the chemically toughened segments is 20-49% by weight, such as 23 to 45% by weight or 32-42% by weight, based on total weight of the chemically toughened epoxy resin component. In an exemplary calculation manner, the ratio of the chemically toughened segments can be obtained by: (the weight of toughening elastomer(s))/(the sum of the weight of toughening elastomer(s)+the weight of non-toughened modified epoxy resin base or epoxy resin base prior to modification).

A particularly preferred chemically toughened epoxy resin is an epoxy resin having polyester segments, that is, a polyester modified epoxy resin. It preferably is an epoxy functional adduct which is prepared from a flexible acid functional polyester and polyepoxide. Linear polyesters generally are more preferred than branched polyesters. Acid functional polyester can be prepared by the polyesterification of an organic polycarboxylic acid or anhydride thereof with an organic polyol. Generally, the polycarboxylic acid and polyol are aliphatic or aromatic diacid and diol. In a preferred embodiment, for example, a C4-10 long chain aliphatic diacid, such as azelaic acid, sebacic acid, and a C3-6 diol or triol, such as butanediol and propanetriol, can be used to react to obtain a linear or branched flexible polyester. Correspondingly, the polyester modified chemically toughened epoxy resins in accordance with the present invention which are obtained by thoroughly mixing a commercially available polyester chemically modified epoxy resin with a non-modified epoxy resin at a suitable ratio can also be used. The details regarding the polyester modified epoxy resins can also be referred to U.S. Pat. No. 5,070,119, the entirety of which is incorporated herein by reference. Thus polyester modified epoxy resin can be commercially obtained, such as, under trade name of JH0711 intermedia.

Another particularly preferred chemically toughened epoxy resin is poly(meth)acrylic modified epoxy resin. Sufficient flexibility can be imparted to an epoxy resin by incorporating flexible long chain poly(meth)acrylic segments through chemical reactions. Thus poly(meth)acrylic modified epoxy resins are also known, which the skilled in the art can commercially obtain or readily prepare according to prior art methods. For example, a grafting copolymer can be formed by incorporating in an acrylate copolymer active groups which then react with epoxy groups or hydroxy groups. Alternatively, the chemically toughened epoxy resin component of the present invention can also be obtained by incorporating thus poly(meth)acrylic chemically modified epoxy resin as a modifying agent into a non-modified epoxy resin base at a suitable ratio.

Polyurethane modified epoxy resins are also suitable. Corresponding polyurethane is introduced to impart epoxy resin flexibility. These polyurethane modified epoxy resins are also known and can be commercially obtained by one skilled in the art or readily prepared by one skilled in the art according to prior art method. For example, PU/EP modified system can be obtained by mixing and reacting isocyanate terminated polyurethane prepolymer and epoxy resin under melting condition. Alternatively, for example, bisphenol A epoxy resin can be grafted with isocyanate groups terminated polyether polyurethane oligomer.

Moreover, applicable chemically toughened epoxy resin also includes polyether modified epoxy resin comprising oxyalkylene groups. These groups can be pendent to epoxy resin backbone or they can be included inside as a part of backbone. The preparation of these polyether modified epoxy resin are also known.

Moreover, some other elastomeric modified epoxy resin, in particular styrenic polymers, polyolefin and polyamide modified epoxy resins, can also be used. Their preparation and categories are also well known to one skilled in the art. In an exemplary embodiment, for example, a commercially available product EPON™ Resin 58034 can be used, which is an elastomeric modified epoxy functional adduct, obtained from the reaction between diglycidyl ether of neopentanediol and carboxylic terminated polybutadiene-acrylonitrile polymer elastomer.

The epoxy resins suitable as the non-toughened epoxy resin and as the chemically toughened epoxy resin base in the present invention composition can be the same or different and generally can be obtained by known manner. They are obtained, for example, from corresponding olefin oxidation, or from reaction between epichlorohydrin and corresponding polyols, polyphenols or amine, in particular the glycidylation reaction of polyphenols, polyols or amine and epichlorohydrin. Epoxy resin generally includes monoepoxide or polyepoxide, in particular polyepoxide having more than one or generally about two 1,2-epoxy groups. Generally, the epoxy equivalent weight range of epoxy resin can be such as about 100 to about 2000, typically about 180 to 500. Epoxy resin can be saturated or unsaturated, cyclic or acyclic, aliphatic, cycloaliphatic, aromatic or heterocyclic. They may contain substituents, such as halogen, hydroxy groups, and ether groups.

Suitable epoxy resins are aromatic epoxy resin, such as, polyglycidol ether of polyphenol, wherein the polyphenol is such as 2,2-bis(4-hydroxylphenyl)propane (bisphenol A), 4,4-dihydroxyl diphenyl methane (bisphenol F), di(4-hydroxylphenyl)-1,1-isobutane, di(4-hydroxyltertbutylphenyl)-2,2-propane, di(2-hydroxylnaphthyl)methane, 4,4′-dihydroxyl benzophenone, resorcinol, hydroquinone, benzenedimethanol, phloroglucinol, and catechol and their mixtures; and/or condensation product of phenol and formaldehyde obtained under acidic condition.

Other suitable epoxy resin includes also aliphatic or cycloaliphatic polyepoxide, in particular the following:

saturated or unsaturated, branched or non-branched, cyclic or opened-chain di-, tri- or tetra functional C₂ to C₃₀ alcohol, in particular ethylene glycol, propylene glycol, butylene glycol, hexylene glycol, octane glycol, polypropylene glycol, dimethylol cyclohexane, neopentyl glycol, dibromo neopentyl glycol, castor oil, trimethylol propane, trimethylolethane, pentaerythritol, sorbitol or glycerol, or alkoxylated glycerol, or glycidyl ether of alkoxylated trimethylolpropane;

hydrogenated bisphenol A, F or A/F liquid resins, or glycidylation products of hydrogenated bisphenol A, F or A/F;

N-glycidyl derivatives of amides or heterocyclic nitrogen bases, such as triglycidyl cyanurate or triglycidyl isocyanurate, or the reaction product of epichlorohydrin and hydantoin;

epoxy resins derived from the oxidation of olefins, such as vinyl cyclohexene, dicyclopentadiene, cyclohexadiene, cyclododecadiene, cyclododecatriene, isoprene, 1,5-hexadiene, butadiene, polybutadiene or divinylbenzene.

Preferred epoxy resins are the epoxy resins based on the aromatic epoxy resins, aliphatic and/or cycloaliphatic epoxy resins, more preferably epoxy resins based on bisphenol (such as bisphenol A, bisphenol F or bisphenol A/F), in particular based on bisphenol A, bisphenol F or bisphenol A/F (such as their diglycidyl ethers) and hydrogenated products thereof.

Moreover, a particularly suitable polyepoxide has less than 200 g/eq. epoxy equivalent weight. Examples thereof includes D.E.R.331 EPDXY RESIN commercially available from Dow Chemical Corporation, NPEL-128E from Nan Ya Plastic Corporation or YD-128 from Kukdo Chemical, etc. Moreover, as suitable modified epoxy resin, commercially available product JH0711 intermedia can also be mentioned, which is a polyester modified epoxy resin based on bisphenol A type epoxy resin.

There is no particularly limitation on the curing agent used in the present invention, as long as it can react with the thermoset polymer used in the present invention, particularly epoxy resin and/or modified epoxy resin, and make them cured. Preferred curing agent includes amines, amine adducts, polyamide and polyether amine, etc., in particular preferably polyamide curing agents.

Amine curing agent are organic polyamine compounds widely used for epoxy resins. Specific amine curing agents include polyamines, the examples thereof including, but not limited to, diethylene triamine, triethylene tetramine, tetraethylene pentamine, isophorone diamine, m-xylylene diamine, m-phenylene diamine, 1,3-bis(aminoethyl) cyclohexane, bis(4-amino cyclohexyl) methane, N-aminoethyl piperazine, 4,4′-diaminodiphenyl methane, 4,4′-diamino-3,3′-diethyldiphenyl methane and diaminodiphenyl sulfone. The commercial grade products of these polyamine curing agents can be used.

Moreover, adducts of any of above polyamines can also be used. The adducts of polyamines are formed by reaction between polyamine and suitable reactive compounds, such as epoxy resins. This reaction will decrease the free amine content in the curing agent, making it more suitable to be used under low temperature and/or high humidity environments.

As a curing agent, various polyether amines, such as various Jeffamines commercially available from Huntsman Corporation can also be used, including, but not limited to, Jeffamine D230, Jeffamine 600, Jeffamine 1000, Jeffamine 2005 and Jeffamine 2070, etc.

As a curing agent, various polyamides can also be used. Generally speaking, polyamides contain reaction product of dimer fatty acid and polyethylene amine and minority of monomeric fatty acid. Dimer fatty acids are prepared by oligomerization of monomeric fatty acids. The polyethylene amine may be any higher polyethyleneamine, such as diethylenetriamine, triethylenetetramine, tetraethylenepentamine, etc., among which diethylenetriamine is the most commonly used. When polyamide is used as the curing agent, it can make the coating have a good balance of corrosion resistance and water resistance. Moreover, polyamide can also make coatings have good flexibility, appropriate curing rate and other favorable properties. An example of commercially available curing agent suitable for the present invention is Polyamide Versamid 150.

Although the amount of the curing agent is not important and can be readily determined by one skilled in the art, in an exemplary advantageous embodiment, the amount of the curing agent is 10-30%, such as is 15-20% by weight, 16-19% by weight, 17-19% by weight, based on the total weight of the composition. Alternatively, the amount of the curing agent in the insulating coating composition of the present invention can be 10, 11, 12, 13, 14 or 15% by weight to 18, 19, 20, 21, 22, 23, 24 or 25% by weight. Each endpoint of the above ranges can be arbitrarily combined to define the amount of the various curing agent in the insulating coating composition of the present invention.

Moreover, the composition of the present invention may also comprise curing accelerator. The curing accelerator is a class of substances capable of accelerating resin's curing process, decreasing curing temperature and shortening curing time. Typical curing accelerators include fatty amine accelerators, such as triethanol amine, triethylene diamine, etc.; anhydride accelerators, such as BDMA, DBU, etc.; polyetheramine catalysts; tin accelerators, such as dibutyltin dilaurate, stannous octoate, etc. In an embodiment of the present invention, the curing accelerator is ANCAMINE K54, which is commercially available from Air Products (Evonik).

In an advantageous embodiment, the amount of the curing accelerator is 2 to 5% by weight, such as 2-3% by weight, based on the total weight of the insulating coating composition.

The present invention insulating coating composition should also comprise one or more reinforcing fibers. The inventors have found that, in particular, those reinforcing fibers preferred in the present invention can enhance the cracking resistance of the substrate under low temperatures or ultralow temperatures.

In principle, there is no particular limitation on the fibers suitable for using in the present invention. Examples include, but not limited to, inorganic fibers and organic fibers. Typical inorganic fibers include carbide fibers, such as boron carbide fiber, silicon carbide fiber, niobium carbide fiber, etc.; nitride fibers, such as silicon nitride fiber; boron-containing fiber, such as boron fiber, boride fiber; silicon-containing fibers, such as silicon fiber, alumina-boron-silicon dioxide fiber, E-glass (alkali-free aluminum borate) fiber, C-glass (alkali-free or low-alkali soda lime-aluminoborosilicate) fiber, A-glass (alkali-alkali lime-silicate) fiber, S-glass fiber, inorganic glass fiber, quartz fiber, etc. In various embodiments of the present invention, preferred glass fibers include E-glass fibers, C-glass fibers, A-glass fibers, S-glass fibers, and the like. Typical organic fibers include, for example, polyester fibers.

In the embodiments of the present invention, useful inorganic fibers also include ceramic fibers. Ceramic fibers are also known as aluminum silicate fibers, because one of their major components is alumina which is the major component of porcelain and thus makes them called as ceramic fibers. The doping of zirconium oxide or chromium oxide can further increase the application temperature of ceramic fibers. Ceramic fibers are of light weight, high temperature resistance, good thermal stability as well as low thermal conductivity, and can be used in various environments of high temperature, high pressure and/or easy-wearing.

In the various embodiments of the present invention, useful inorganic fibers also include basalt fibers. Basalt fibers are continuous fibers formed by high-speed drawing basalt stones through platinum rhodium alloy bushing plate after melting at 1450° C. to 1500° C. The basalt fibers have a strength comparable to high strength S-glass fibers.

In the insulating coating composition of the present invention, the amount of the reinforcing fibers is 2.1 to 6%, based on the total weight of the insulating coating composition, such as up to 5% by weight, up to 4% by weight, preferably 2.5 to 5% by weight, such as 3 to 4.5% by weight. Excessive reinforcing fibers could result in an unduly increasing viscosity of the composition, affecting workability.

Preferably, the reinforcing fibers include at least one of polyester fibers, mineral fibers, ceramic fibers, glass fibers, carbon fibers and basalt fibers, and more preferably select from at least one of glass fibers, carbon fibers and ceramic fibers.

In another preferred embodiment, the length of the reinforcing fibers is between 1 mm and 10 mm. According to the present invention, in case of excessively large length the workability would be adversely affected, while in case of excessively small length the low temperature cracking resistance would be adversely affected.

The composition according to the present invention also includes low-density fillers having a density ranging from 0.05 to 0.7 g/cm³, preferably 0.08 to 0.5 g/cm³, more preferably in the range of 0.1 to 0.4 g/cm³. In the present invention, ensuring the low density of the fillers is important. The inventors of the present invention have unexpectedly found, if low density fillers, in particular a combination of hollow glass bubbles with organic polymer microspheres, are included in the insulating coating composition of the present invention, then very superior low temperature cracking resistance can be obtained without impairing the flexibility of the composition, if not enhanced.

The hollow glass bubbles suitable for using in the present invention are bubble-shaped microspheres with hollow structure made of glass material, which are known materials in filler art and generally have high compressive strength. These hollow glass bubbles can be commercially obtained, for example, as 3M™ glass microspheres K, S and iM serial products obtain, such as 3M Glass bubble VS5500.

Organic polymer microspheres generally refer to polymer particles having a circular or nearly circular shape and a particle size in the range of tens of nanometers to hundreds of micrometers. The production and preparation thereof are known and they can be widely commercially obtained.

In the scope of the present invention, the organic polymer microspheres preferably are solid, that is, non-hollow polymer microspheres. Comparing with polymer microspheres with a non-solid or hollow structure, it has been found that solid organic polymer microspheres are more favored for the composition's toughness and low temperature cracking resistance at low temperature. Moreover, the organic polymer microspheres can also include polymers with core-shell structure.

As suitable polymer microspheres, natural or synthetic elastomeric or rubbery polymer materials having certain compressive strength can be selected out, for example, including at least one of acrylonitrile polymer, polystyrenes, poly(meth)acrylates, polyolefin, starches, polylactic acid, natural rubber, styrene-butadiene rubber, carboxylic styrene-butadiene rubber, butadiene-acrylonitrile rubber, carboxylic butadiene-acrylonitrile rubber, polybutadiene rubber, silicon rubber, chloroprene rubber, acrylic rubber, butadiene-styrene-vinylpyridine rubber, isoprene rubber, butyl rubber, polysulfide rubber, acrylate-butadiene rubber, polyurethane rubber, fluoro rubber and ethylene-vinylacetate polymer. Alternatively, they can be also copolymers or copolymers with core-shell structure formed by the above-mentioned polymers or the monomers forming the above-mentioned polymers, or mixture thereof. In a preferred embodiment, the polymer microspheres comprise acrylonitrile polymer, polystyrenes, poly(meth)acrylates, polyolefin, polybutadiene rubber, ethylene-vinylacetate polymer, or the copolymers with core-shell structure formed by the above-mentioned polymers or the monomers forming the above-mentioned polymers, or mixtures thereof. Particularly preferably, the polymer microspheres are microspheres having acrylonitrile polymer shell.

Moreover, the polymer microspheres can be surface coated, such as with inorganic mineral powders. Suitable inorganic mineral powders include, but not limited to, such as, talc, calcined kaolin, limestone, calcium carbonate, wollastonite, fumed silica, etc., preferably calcium carbonate. These organic polymer microspheres can be commercially obtained for example as DUALITE E 130-095D products.

Moreover, inventors have found that, in order to achieve the best effects of the invention, the amount of the low density fillers should be advantageously controlled in the range of 5 to 60% by weight, preferably 7-50% by weight, more preferably 10-30% by weight, based on the total weight of the coating composition. Preferably, low density fillers consist of hollow glass bubbles and organic polymer microspheres, and the composition comprises 5 to 30% by weight, such as preferably 8 to 21% by weight or 8 to 15% of hollow glass bubbles and 5 to 20% by weight, such as preferably 7-15% by weight or 8 to 12% of organic polymer microspheres. In a preferred embodiment, the mass ratio of hollow glass bubbles to organic polymer microspheres is from 0.6:1 to 2:1, such as from 1:1 to 1.6:1.

In the insulating coating composition of the present invention, preferably, the amount of the various inorganic additives is 15 wt %-45 wt %, based on the total weight of the insulating coating composition, such as 15 wt %-35 wt %, 15 wt %-30 wt %, or 15 wt %-25 wt %. Alternatively, the amount of the inorganic additive in the insulating coating composition of the present invention can be 15, 16, 17, 18, 19, 20, 21, 22, 23 or 24 wt % to 31, 32, 33, 34, 35, 36, 37, 38, 39 or 40 wt %. The endpoints of the above ranges can be arbitrarily combined to define the amount of the inorganic additive in the insulating coating composition of the present invention.

The insulating coating composition of the present invention may further comprise additionally one or more optional ingredients and/or additives, such as solvent, other curing catalysts, pigments or other colorants, reinforcements, thixotropes, accelerators, surfactants, plasticizers, extenders, stabilizers, corrosion inhibitors, diluents, hindered amine light stabilizers, UV light absorbers, adhesion promoters, and antioxidants. Alternatively, the above ingredients and/or additives also can be used to form a mixture comprised in the insulating coating composition of the present invention with other components in the insulating coating composition of the present invention.

In an advantageous embodiment, the insulating coating composition according to the present invention further comprises plasticizers suitable for the epoxy resin of the present invention, including, but not limited to carboxylic acid esters such as phthalates, especially diisononyl phthalate (DINP), diisodecyl phthalate (DIDP) or di (2-propylheptyl) phthalates (DPHP), hydrogenated phthalates, especially hydrogenated diisononyl phthalate (DINCH), terephthalates, especially dioctyl terephthalate, trimellitate, adipate, especially dioctyl adipate, azelate, sebacate, polyol, especially polyoxyalkylene polyol or polyester polyol, benzoates, glycol ethers, glycol esters, organic phosphates, phosphonates or sulfonates, polybutene, polyisobutylene, or plasticizers derived from natural fats or oils, especially epoxidized soybean oil or linseed oil. The amount of plasticizers is preferably from 5 to 15%, such as 6-10%, based on the total weight of the composition.

In an advantageous embodiment, the insulating coating composition according to the present invention comprises at least one low viscosity diluent, the amount of which preferably is from 5 to 20%, such as 6-15%, based on the total weight of the composition. These diluents are used to decrease viscosity of the epoxy resins and well known to one skilled in the art, including monofunctional epoxy diluents, long-chain cashew nut shell oil modified diluents and other low viscosity non-reactive diluents, etc. They can be commercially obtained for example as NX 4708, Epotuf 37-058 and grilonit RV1812.

The insulating coating composition of the present invention can be prepared by any method well known to one skilled in the art. In the method for preparing the insulating coating composition of the present invention, the above components can be mixed at a desired ratio. In an embodiment, the above components are sequentially charged into a container, and then stirred until homogenous. There is no particularly limitation on the order of the additions of the components.

The present invention further relates to a coated substrate, on which the insulating coating composition according to the present invention is coated. The low temperature cracking property of such coated substrate can be significantly enhanced.

Suitable substrates include rigid metal substrates such as ferrous metals, aluminum, aluminum alloys, copper, and other metal and alloy substrates. The ferrous metal substrates used in the practice of the present invention may include iron, steel, and alloys thereof. Non-limiting examples of useful steel materials include cold rolled steel, galvanized (zinc coated) steel, electrogalvanized steel, stainless steel, pickled steel, zinc-iron alloy such as GALVANNEAL, and combinations thereof. Combinations of ferrous and non-ferrous metals or composites can also be used. The substrate according to the present invention may comprise a composite material such as a plastic or a fiberglass composite. A particularly suitable substrate is steel, especially steel construction. The steel construction includes, for example, offshore oil platforms, LNG storage tanks, transportation pipelines, transportation vehicles such as ships, vehicles and trains, especially those using LNG as energy source.

Before depositing any coating compositions upon the surface of the substrate, it is common practice, though not necessary, to remove foreign matter from the surface by thoroughly cleaning and degreasing the surface. Such cleaning typically takes place after forming the substrate (stamping, welding, etc.) into an end-use shape. The surface of the substrate can be cleaned by physical or chemical means, such as mechanically abrading the surface or cleaning/degreasing with commercially available alkaline or acidic cleaning agents which are well known to those skilled in the art, such as sodium metasilicate and sodium hydroxide. A non-limiting example of a cleaning agent is CHEMKLEEN 163, an alkaline-based cleaner commercially available from PPG Industries, Inc.

Following the cleaning step, the substrate may be rinsed with deionized water, with a solvent, or an aqueous solution of rinsing agents in order to remove any residue. The substrate can be air dried, for example, by using an air knife, by flashing off the water by brief exposure of the substrate to a high temperature or by passing the substrate between squeegee rolls.

The substrate may be a bare, cleaned surface; it may be oily, pretreated with one or more pretreatment compositions, and/or prepainted with one or more coating compositions, primers, topcoats, etc., applied by any method including, but is not limited to, electrodeposition, spraying, dip coating, roll coating, curtain coating, and the like. Therefore, the substrate can be already coated with at least one functional coating, and then the above insulating coating composition is coated onto that coating. In an advantageous embodiment, the insulating coating composition of the present invention can be directly coated onto the substrate or the functional coating without using any intermediate layers.

In an advantageous embodiment, in order to protect the flame resistant coating on the substrate to increase firing property thereof, the insulating coating composition according to the present invention can be applied over the coating having flame resistant ability (that is, flame resistant coating) existing on the substrate. Here, the insulating coating composition of the present invention capable of thermal insulation protection can be directly on top of the flame resistant coating, or can be indirectly applied on the flame resistant coating via intermediate layer(s). There also can be at least one other functional coating between the thermal insulation coating according to the present invention and the flame resistant coating. Therefore, the present invention also relates to a substrate, wherein at least one additional coating which composition is different from the insulating coating composition according to the instant invention is coated on the substrate, preferably said additional coating being flame resistant coating.

The flame resistant coating, preferably an intumescent coating, generally comprises components selected from acid source, intumescent agent (foaming agent) and carbon source.

The acid source will produce acid(s) when the flame resistant coating is exposed to fire or heat. Suitable acid source includes, but not limited to, phosphorus containing acid source and sulphur containing acid source. The phosphorus containing acid source includes phosphorates, such as sodium phosphorate, potassium phosphorate or ammonium phosphorate, ammonium polyphosphorate (APP), monoammonium phosphorate, diammonium phosphorate, trichloroethyl phosphate (TCEP), trichloropropyl phosphate (TCPP), ammonium pyrophosphorate, triphenyl phosphate, etc. Sulphur containing acid source includes sulfonates, such as sodium sulfonate, potassium sulfonate or ammonium sulfonate, paratoluene sulfonate, sulphates, such as sodium sulphate, potassium sulphate or ammonium sulphate.

Intumescent agent will produce nonflammable gases, generally nitrogen, when exposed to fire or heat. The produced gases will expand the char derived from the carbon source, forming a foam-like protective layer. The intumescent agent generally may include, but not limited to, melamines and boron-containing compounds, such as melamine salts, such as melamine cyanurate, melamine formaldehyde, methylolated melamine, hexamethoxymethyl melamine, melamine monophosphate, bis(melamine phosphate), melamine phosphoric acid dihydrogen salts, etc.; or boric acid, and borate salts, such as ammonium pentaborate, zinc borate, sodium borate, lithium borate, aluminum borate, magnesium borate, and borosilicate.

The carbon source transforms into char upon exposure to fire or heat, thereby forming an anti-fire protective layer on the substrate. The carbon sources can be for example aromatic compounds (such as those having long chain hydrocarbon substituents) or tall oil fatty acid (TOFA).

However, preferably, the insulating coating composition of the present invention is distinguished from a flame resistant coating composition, and thus the composition of the present invention does not comprise components selected from acid sources, intumescent agents (foaming agents) and carbon sources.

The insulating coating composition of the present invention can be applied to a substrate by one or more methods, including spray coating, dip coating/impregnating, brush coating or flow coating, with spray coating most often used for applying. For example, heatable double-tube charging airless spray coating apparatus, such as WIWA Duomix 333 PFP or similar apparatus, can be used. Common wire heating double-tube charging spray coating apparatus, such as Graco XM70 serials, can be also used. Even pumps like WIWA HERKULES 35075 PFP can be used to apply after premix. The dry film thickness of the coating typically is from 0.1 to 40 mm, such as from 0.5 to 20 mm, from 0.5 to 18 mm, from 0.8 to 16 mm. Alternatively, the coating thickness of the insulating coating composition of the present invention may be 0.1, 0.2, 0.3, 0.4, 0.5, 0.6, 0.7, or 0.8 mm to 10, 11, 12, 13, 14, 15, 16, 17, 18, 19 or 20 mm. Alternatively, the coating thickness of the insulating coating composition of the present invention may be 1, 2, 3, 4, 5 or 6 mm to 30, 31, 32, 33, 34, 35, 36, 37, 38, 39 or 40 mm.

Finally and correspondingly, the present invention relates to a method for protecting a substrate, including the following steps:

(1) providing a substrate optionally coated with a first coating; and

(2) applying the above insulating coating composition on the substrate or the first coating on the substrate,

wherein, advantageously, the first coating and the insulating coating according to the present invention are different in regard to the composition and function. Preferably, the first coating is the above functional coating, more preferably the above flame resistant coating.

The following examples are intended to illustrate the various embodiments of the present invention, but should not be construed as limiting the present invention in any means.

### Examples

1. List of Main Raw Materials Used

| Name | Remarks |
|---|---|
| Epoxy 828 | Bisphenol A type epoxy resin |
| JH0711 intermedia | Polyester modified epoxy resin based on |
| | Epoxy 828 (wherein the amount of |
| | polyester segments is 50%, based on the |
| | total weight of the modified epoxy resin) |
| Polyamide Versamid 150 | Low viscosity reactive polyamide resins |
| Jeffamine D230 | Polyether amine D230 |
| Chopped glass fibers | Glass fibers of 3 to 4.5 mm |
| 3M Glass Bubble VS5500 | Hollow glass bubbles, having a density |
| | about 0.38 g/cm³ |
| Dualite E30-095D | Calcium carbonate coated microspheres |
| | having acrylonitrile polymer shell with a |
| | density about 0.13 g/cm³ |

2. Preparation of Insulating Coating Composition

Each insulating coating composition sample was formulated in accordance with the ingredients and their weight ratio listed in Table 1:

Epoxy resin Epoxy 828 and JH0711 intermedia were poured at the indicated ratio into a container with a dispersion device. Under slow stirring of 10 minutes, the epoxy resin diluent was added until homogenous. Glass fibers were added while dispersing. After 1 to 2 hours of high speed stirring, the fiber filaments which were bundled together were scattered. Next, the hollow glass bubbles and polymer modified fillers were added while slowly cooling with water. The temperature of the whole process was controlled at no more than 70 degrees. At last, thickening auxiliaries were added and mixed homogenously, and a binder was obtained.

Versamid 150 and Jeffamine D 230 were added into a container with a dispersion device, and then the catalyst was added. Slowly stirring until homogeneous. After 1 to 2 hours of high speed stirring, the fiber filaments which were bundled together were scattered. Thickening auxiliaries were added and thoroughly dispersed for 10 minutes. 3M Glass bubble VS5500 and Dualite E30-095D were slowly added while cooling with water, and mixed homogenously. The temperature of the whole process was controlled not more than 70 degrees, and a curing agent was obtained.

TABLE 1
Composition of Each Sample

| | Sample | Sample | Sample | Sample | Sample |
|---|---|---|---|---|---|
| | 1 | 2 | 3 | 4 | 5 |
| Epoxy 828 | 7 | 40 | 7 | 7 | 7 |
| JH0711 intermedia | 33 | 0 | 33 | 33 | 33 |
| Polyamide Versamid 150 | 13 | 13 | 13 | 13 | 13 |
| Jeffamine D230 | 6 | 6 | 6 | 6 | 6 |
| Chopped Glass Fibers | 3.3 | 3.3 | 0 | 3.3 | 3.3 |
| 3M Glass bubble V55500 | 12 | 12 | 12 | 0 | 24 |
| Dualite E30-095D | 7 | 7 | 7 | 11 | 0 |
| Diluent and Plasticizer | 14.7 | 14.7 | 14.7 | 14.7 | 14.7 |
| Other Auxiliaries Including | 3.1 | 3.1 | 3.1 | 3.1 | 3.1 |
| Thickening Auxiliary | | | | | |

3. Properties Test

Flexibility and Low Temperature Cracking Resistance

Liquid Nitrogen Immersion Experiment:

A flat steel panel having a length of 500 mm, a width of 500 mm and a thickness of 10 mm was subjected with its surface to sanding and coated with epoxy primer (an epoxy primer, Sigmacover 280, produced by PPG Industries). Then, the insulating coating composition sample to be tested was applied to the flat panel surface with a film thickness of 12 mm. The prepared test specimen was cured at room temperature for 24 hours, and then at 60° C. for another 4 hours. Next, a frame was installed on the specimen's surface with the gap between the frame and the flat panel being filled with sealant. The liquid nitrogen of −196° C. was poured into the frame at a certain amount, and the temperature at the backside of the flat panel was measured. The coating was observed for the possible cracks and the time needed for reaching the temperature limit was recorded. Experiments results were shown in the following Table 2.

TABLE 2

| | | | | | | Commercial |
|---|---|---|---|---|---|---|
| | | | | | | insulating |
| | | | | | | coating based |
| | Sample 1 | Sample 2 | Sample 3 | Sample 4 | Sample 5 | on bisphenol A |
| Thickness of the | 12 mm | 12 mm | 12 mm | 12 mm | 12 mm | 12 mm |
| film | | | | | | |
| Hardness Shore | 28 | >80 | 28 | 47 | 16 | >80 |
| D (168 hrs) | | | | | | |
| Time needed for | 30 mins | 8 mins | 15 mins | 25 mins | 24 mins | 12 mins |
| temperature | | | | | | |
| descending from | | | | | | |
| 23° C. to −29° C. | | | | | | |
| Cracking | No | Cracking | one big | Four | No crack, | Cracking from |
| Resistance | Cracking | from | crack | cracks of | relatively | coating surface |
| | | coating | having a | less than 3 | low | through primer |
| | | surface | length of | cm, not | hardness | layer, liquid |
| | | through | 15 cm and | reaching | | nitrogen |
| | | primer | a width of | primer or | | directly |
| | | layer, | 1 mm | substrate, | | touching |
| | | liquid | found on | relatively | | substrate |
| | | nitrogen | the surface | high | | |
| | | directly | | hardness | | |
| | | touching | | | | |
| | | substrate | | | | |

4. Comparative Experiments

(1) Study on the Modified Epoxy Resin Component

Samples 1-1, 1-2, 1-3 and 2 were prepared as above with the compositions shown in Table 3 below, mainly changing the compositions of the modified epoxy resin component. The drying situations of the resins were examined without the addition of glass fibers and low-density fillers.

TABLE 3

| | Sample | Sample | Sample | Sample | Sample |
|---|---|---|---|---|---|
| | 1-1 | 1 | 1-2 | 1-3 | 2 |
| Epoxy 828 | 0 | 7 | 13 | 20 | 40 |
| JH0711 intermedia | 40 | 33 | 27 | 20 | 0 |
| Polyamide Versamid 150 | 13 | 13 | 13 | 13 | 13 |
| Jeffamine D230 | 6 | 6 | 6 | 6 | 6 |
| Diluent and Plasticizer | 14.7 | 14.7 | 14.7 | 14.7 | 14.7 |
| Other Auxiliaries | 2 | 2 | 2 | 2 | 2 |
| Resin Hardness Shore D | 2 | 11 | 13 | 17 | 60 |
| (48 hrs) | | | | | |
| Resin Hardness Shore D | 12 | 28 | 30 | 40 | >80 |
| (168 hrs) | | | | | |

As shown in Table 3, when using only 50% polyester segments modified epoxy resin (Sample 1-1), drying rate decreased and the resin system was still tacky by hand touch after 7 days. In contrast, when using only non-modified epoxy resin (Sample 2), the resin system dried too fast and too hard.

(2) Study on the Amount of the Glass Fibers

Samples 1-4, 1-5, 1-6, 1-7 and 2 were prepared as above with the compositions shown in Table 3 below, mainly changing the amount of the glass fibers.

TABLE 4

| | | Sample | Sample | Sample | Sample | Sample |
|---|---|---|---|---|---|---|
| | Sample 1 | 1-4 | 1-5 | 1-6 | 1-7 | 1-8 |
| Epoxy 828 | 7 | 7 | 7 | 7 | 7 | 7 |
| JH0711 intermedia | 33 | 33 | 33 | 33 | 33 | 33 |
| Polyamide Versamid 150 | 13 | 13 | 13 | 13 | 13 | 13 |
| Jeffamine D230 | 6 | 6 | 6 | 6 | 6 | 6 |
| Chopped glass fibers | 3.3 | 1.5 | 2.0 | 4.8 | 5.4 | 6.5 |
| 3M Glass bubble VS5500 | 12 | 12 | 12 | 12 | 12 | 12 |
| Dualite E30-095D | 7 | 7 | 7 | 7 | 7 | 7 |
| Diluent and Plasticizer | 14.7 | 14.7 | 14.7 | 14.7 | 14.7 | 14.7 |
| Other Auxiliaries | 3.1 | 3.1 | 3.1 | 3.1 | 3.1 | 3.1 |
| Cracking resistance | No | Many | Several | No | No | No |
| | cracking | large | large | cracking | cracking | cracking, |
| | | cracks | cracks | | | viscosity |
| | | | | | | relatively |
| | | | | | | high |

As shown in Table 4, after the ratio of the glass fibers reached over 3%, substantially no cracking or only tiny cracks at surface were found, but excessive glass fibers (such as Sample 1-8) would result in too high viscosity of the system to process.

(3) Study on Low-Density Fillers

Samples 1-9, 1-10 and 1-11 were prepared as above with the compositions shown in Table 5 below, mainly changing the amount of the low-density fillers.

TABLE 5

| | Sample | Sample | Sample | Sample |
|---|---|---|---|---|
| | 1 | 1-9 | 1-10 | 1-11 |
| Epoxy 828 | 7 | 7 | 7 | 7 |
| JH0711 intermedia | 33 | 33 | 33 | 33 |
| Polyamide Versamid 150 | 13 | 13 | 13 | 13 |
| Jeffamine D230 | 6 | 6 | 6 | 6 |
| Chopped Glass Fibers | 3.3 | 3.3 | 3.3 | 3.3 |
| 3M Glass bubble V55500 | 12 | 6.4 | 27.3 | 0 |
| Dualite E30-095D | 7 | 8 | 0 | 10.8 |
| Diluent and Plasticizer | 14.7 | 14.7 | 7 | 7 |
| Other Auxiliaries | 3.1 | 3.1 | 33 | 33 |
| Density | 0.533 | 0.5 | 0.6 | 0.45 |
| Hardness Shore D (168 hrs) | 28 | 25 | 47 | 16 |
| Time needed for temperature | 28.5 | 26 | 25.5 | 24 |
| descending from 23° C. to | | | | |
| −29° C., 12 mm | | | | |
| Cracking resistance | No | Tiny | Tiny | No |
| | cracking | cracks | cracks | cracking |
| | | on | on | |
| | | surface | surface | |

As shown in Table 5, although both hollow glass bubbles and organic polymer microspheres can increase cracking resistance, the samples containing hollow glass bubbles would have a higher density and a higher hardness with a slightly lower cracking property while the samples containing organic polymer microspheres would have lighter weight with slower drying.

Whereas particular embodiments of this invention have been described above for purposes of illustration, it will be evident to those skilled in the art that numerous variations of the details of the present invention may be made without departing from the scope of the invention as defined in the appended claims.

1. An insulating coating composition, comprising at least
a) a chemically toughened epoxy resin component, wherein a ratio of chemically toughened segments, which are elastomeric segments and bonded via chemical reaction on the epoxy resin, is in a range of 20-49 wt %, based on a total weight of said chemically toughened epoxy resin component;
b) a curing agent;
c) reinforcing fibers; and
d) low-density fillers with a density ranging from 0.05-0.7 g/cm³.

2. The insulating coating composition according to claim 1, wherein the ratio of chemically toughened segments is in a range of 23-45 wt %.

3. The insulating coating composition according to claim 1, wherein said chemically toughened epoxy resin component comprises at least one selected from polyester modified epoxy resin, poly(meth)acrylic modified epoxy resin, polyurethane modified epoxy resin, polyether modified epoxy resin, styrene polymers modified epoxy resin, polyolefin modified epoxy resin and polyamide modified epoxy resin.

4. The insulating coating composition according to claim 1, wherein said chemically toughened epoxy resin component is based on the epoxy resin selected from aromatic epoxy resin, aliphatic and/or cycloaliphatic polyepoxide.

5. The insulating coating composition according to claim 1, wherein the insulating coating composition contains a thermoset polymer matrix as binder and said chemically toughened epoxy resin component constitutes at least 60 wt % of the thermoset polymer matrix binder in the composition.

6. The insulating coating composition according to claim 1, wherein an amount of said curing agent is from 10 to 30 wt % based on a total weight of the composition.

7. The insulating coating composition according to claim 1, wherein an amount of said reinforcing fibers is in a range of 2.1-6 wt % based on a total weight of the composition.

8. The insulating coating composition according to claim 1, wherein an amount of said low-density fillers is in a range of 5-60 wt % based on a total weight of the composition.

9. The insulating coating composition according to claim 1, wherein said low-density fillers contain the combination of hollow glass bubbles and organic polymer microspheres.

10. The insulating coating composition according to claim 1, wherein said composition contains 5-30 wt % of hollow glass bubbles and 5-20 wt % of organic polymer microspheres, in each case based on the total weight of the composition.

11. The insulating coating composition according to claim 9, wherein a mass ratio of hollow glass bubbles to organic polymer microspheres is from 0.6:1 to 2:1.

12. The insulating coating composition according to claim 9, wherein said organic polymer microspheres are solid and selected from natural or synthetized elastomeric or rubbery polymers.

13. The insulating coating composition according to claim 12, wherein said polymer microspheres contain acrylonitrile polymers, polystyrenes, poly(meth)acrylates, polyolefins, polybutadiene rubber, ethylene-vinylacetate polymer, or copolymers with core-shell structure formed by the above-mentioned polymers or the monomers forming the above-mentioned polymers, or mixture thereof.

14. The insulating coating composition according to claim 12, wherein said polymer microspheres are covered by inorganic mineral powders which are selected from talc, calcined kaolin, limestone, calcium carbonate, wollastonite and/or fumed silica.

15. The insulating coating composition according to claim 1, wherein said curing agent contains at least one selected from amines, amine adducts, polyamide and polyetheramine.

16. The insulating coating composition according to claim 1, wherein said reinforcing fibers contain at least one selected from polyester fibers, mineral fibers, ceramic fibers, glass fibers, carbon fibers, and basalt fibers.

17. The insulating coating composition according to claim 1, wherein said composition further contains from 5 to 15% of a plasticizer and/or from 5 to 20% of a diluent, based on a total weight of the composition.

18. A substrate, on which the insulating coating composition according to claim 1 is coated.

19. The substrate according to claim 18, wherein said substrate is a metallic substrate.

20. The substrate according to claim 18, wherein at least one additional coating which composition is different from the insulating coating composition according to claim 1 is coated on the substrate.

21. The substrate according to claim 20, wherein said at least one additional coating is an intumescent coating containing the components selected from an acid source, an intumescent agent and a carbon source.

22. A method for protecting a substrate, including the following steps:
(1) providing a substrate optionally coated with a first coating; and
(2) applying the insulating coating composition according to claim 1 on the substrate or the first coating.

23. The method according to claim 22, wherein said substrate is a metallic substrate.

24. The method according to claim 22, wherein the first coating is an intumescent coating containing the components selected from an acid source, an intumescent agent and a carbon source.
